(19) United States
(12) Patent Application Publication
(10) Pub. No.: US 2007/0190447 A1
(43) Pub. Date: Aug. 16, 2007

(54) Photoresist composition and method of forming resist pattern

(75) Inventors: Toshiyuki Ogata, Kanagawa (JP); Takuma Hojo, Kanagawa (JP); Hiromitsu Tsuji, Kanagawa (JP); Takako Hirosaki, Kanagawa (JP); Mitsuru Sato, Kanagawa (JP)

Correspondence Address: HOFFMANN & BARON, LLP, 6900 JERICHO TURNPIKE, SYOSSET, NY, 11791, US

(73) Assignee: Tokyo Ohkakogyo Co. LTD., Kawasaki-shi (JP)

(21) Appl. No.: 10/589,382

(22) PCT Filed: Feb. 1, 2005
(86) PCT No.: PCT/JP05/01392

§ 371 Date: Aug. 15, 2006

(30) Foreign Application Priority Data
Feb. 19, 2004 (JP) 2004-043692

(51) Int. Cl. G03C 1/00

(52) U.S. Cl. 430/270.1

(57) ABSTRACT

The photoresist composition is formed by including the fullerene derivative (A) having two or more malonic ester residues. Preferably, the malonic ester residue is, a group is preferably expressed by the general formula (1) below. 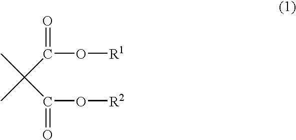
In the formula (1), R¹ and R² independently represent an alkyl group, which may be identical or different from each other. The alkyl group is a normal or branched chain, or cyclic alkyl group having 1 to 10 carbons, and n is an integer from 2 to 10.

### TECHNICAL FIELD

The present invention relates to a photoresist composition and a method for forming a resist pattern by using thereof. Specifically, the present invention relates to a photoresist composition that has superior etching resistance and reduced edge roughness by containing a fullerene derivative having superior solubility as a resist solvent, and a method of forming the resist pattern by using thereof. This application is based on and claims the benefit of priority from Japanese Patent Application No. 2004-043692, filed on Feb. 19, 2004, the content of which is incorporated herein by reference.

### BACKGROUND ART

A lithography method is frequently used for producing a microstructure in a semiconductor device, a liquid crystal device, or the like. However, together with the microfabrication of a device structure, a finer resist pattern is required in a lithography process.

Even though, in the most advanced areas nowadays, for example, the lithography method can form a fine resist pattern which has a line width of about 90 nm, a finer pattern configuration will be desired in future.

To achieve the pattern configuration having a line width of 90 nm or less, it is essential that the wavelength of irradiations, such as an ArF excimer laser, F₂ excimer laser, EUV (extreme ultraviolet), EB (electron beam), X-ray, soft X-ray, and the like, be shortened. Therefore, it is required that a sensitive material and a photoresist associated with the irradiations be developed.

Conventionally, for this kind of sensitive material and the photoresist, a composition in combination with a resin component, such as a (meth)acryl, polyhydroxystyrene or novolac resin, and a radiation sensitive acid generator, or a photosensitive agent is used as a film forming component. However, even if this kind of composition forms a finer pattern having superior resolving ability by using a thin resist film, the etching resistance becomes insufficient. In addition, in a fine pattern having superior solving ability in nanometers it is difficult to reduce edge roughness from conventional levels; therefore, it is strongly desired that the pattern be improved.

Meanwhile, photoresists using a variety of fullerenes have been proposed. (e.g. see Patent Documents 1 to 3). However, the fullerene used for a conventional photoresist tends to have insufficient solubility as a resist solvent. In addition, the solution, in which fullerene is dissolved, has low viscosity, so that it is difficult to form a high-quality photoresist film on a substrate with a coating method, such as a spin coat method. Furthermore, even if a film is formed in this way, it can only be such a thin film that it is difficult to adjust the thickness of the film. Moreover, there is a trade-off problem, such that when the amount of fullerene is increased in the soluble range and etching resistance is improved, there is a deterioration of the resist pattern configuration.

Patent Document 1: Japanese Unexamined Patent Application, First Publication No. 07-33751

Patent Document 2: Japanese Unexamined Patent Application, First Publication No. 09-211862

Patent Document 3: Japanese Unexamined Patent Application, First Publication No. 11-258796

The object of the present invention, based on the above-mentioned example, is to provide a photoresist composition having superior etching resistance by including a fullerene derivative having superior solubility in a resist solvent, which remarkably reduces edge roughness, and a method for forming resist pattern by using thereof.

The object of the present invention is to provide a photoresist composition with a superior resist pattern and a method for forming resist pattern by using thereof.

### DISCLOSURE OF THE INVENTION

Considerable research with reference to substituents of fullerene derivative and numbers thereof has been carried out to solve the problem and it has been found that a fullerene derivative having a specific substituent, in particular, plural specific substituents, exhibits superior solubility in resist solvent. Furthermore, it has been found that a photoresist composition including the methanofullerene derivative exhibits not only the superior effect of remarkably reducing edge roughness, but also superior etching resistance. Moreover, the present invention has been achieved based on these findings. In addition, it has been found that this kind of photoresist composition has a superior sensibility and resist pattern configuration, and that the present invention has been achieved based on these findings.

In other words, the photoresist composition of the present invention is a photoresist composition including the fullerene derivative (A) having two or more malonic ester residues or more. The malonic ester residue is preferably expressed by the general formula (1) below.

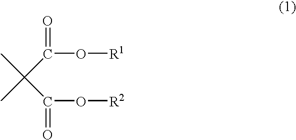

In the formula (1), R¹ and R² independently represent an alkyl group, which may be identical or different from each other.

Furthermore, in the photoresist composition of the present invention, the fullerene derivative (A) is preferably the compound expressed by the general formula (2) below.

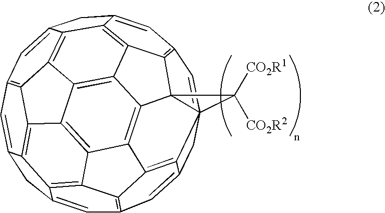

In the formula (2), n is an integer of 2 or more, and R¹ and R² independently represent an alkyl group, which may be identical or different from each other.

The alkyl group is preferably a liner, branched or cyclic alkyl group that has 1 to 10 carbons, and n is an integer from 2 to 10.

The photoresist composition of the present invention further includes the radiation sensitive acid generator (B) and an organic solvent. The photoresist composition of the present invention further includes the film forming resin component (C). In addition, a positive-type photoresist, in which the component (C) is the resin (C1) having an acid-dissociative dissolution-controlling group, which increases solubility in alkali by acid action, is preferred. A negative-type photoresist, in which the component (C) is the alkaline soluble resin (C2), which further includes the crosslinking agent component (D), is preferred. These compositions may further include a nitrogen-containing organic compound and an organic carboxylic acid.

The method for forming the resist pattern of the present invention includes steps of: coating the photoresist composition onto a substrate to form a resist film, exposing the resist pattern, and developing the photoresist film after the exposure to form a resist pattern.

The photoresist composition including the fullerene derivative of the present invention has superior etching resistance, and reduced edge roughness. Furthermore, the photoresist composition of the present invention can form a resist pattern in superior formation.

### PREFERRED MODE FOR CARRYING OUT THE INVENTION

Preferred modes of the present invention will be explained in the following. The photoresist composition of the present invention includes the fullerene derivative (A) having two or more malonic ester residues. The photoresist composition including the fullerene derivative of the present invention, in which the fullerene derivative (A) has superior solubility in organic (resist) solvent, can incorporate fullerene in sufficient amount. As a result, the resist pattern having superior etching resistance, sensibility, and remarkably reduced edge roughness, can be formed in superior formation.

For the malonic ester residue is preferably expressed by the general formula (1) below.

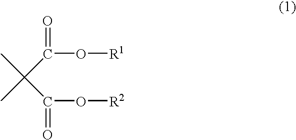

In the formula (1), R¹ and R² independently represent, an alkyl group, which may be identical or different from each other.

The fullerene derivative (A) is preferably the compound, which is methanofullerene expressed by the general formula (2).

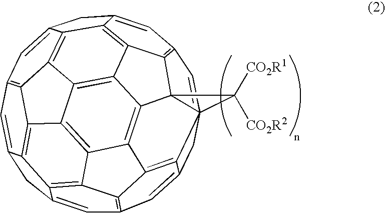

In the formula (2), n is an integer of 2 or more, and R¹ and R² independently represent an alkyl group, which may be identical or different from each other.

The photoresist composition of the present invention further is preferably formed by dissolving the fullerene derivative (A) and the radiation sensitive acid generator (B) in an organic solvent. In addition, the photoresist composition of the present invention further is preferably formed by dissolving the fullerene derivative (A), the acid generator (B), and the film forming the resin component (C) in an organic solvent. In addition, the positive-type photoresist composition of the present invention is formed by dissolving the fullerene derivative (A), the acid generator (B), and the film forming the resin component (C1) that has an acid-dissociative dissolution-controlling group to increase solubility in alkali, in an organic solvent. Furthermore, the negative-type photoresist composition of the present invention is formed by dissolving the fullerene derivative (A), the acid generator (B), the film forming the resin component (C2) that is alkaline soluble resin, and the crosslinking agent component (D), in an organic solvent. These compositions may further include a nitrogen-containing organic compound, an organic carboxylic acid, or both.

This photoresist may use wavelengths from an irradiation source, such as KrF, ArF, F₂, EUV, EB (electron beam), X-ray, and the like, for exposure, but the irradiation source is not limited. Among these, in particular, EUV, EB (electron beam) is preferred.

In the fullerene derivative (A) having the two or more malonic ester residues, the fullerene is a compound that has a molecular structure including of carbon atoms in spherical shell shape. For example, among the fullerenes, C₆₀, C₇₀, C₇₆, C₇₈, C₈₂, C₈₄, C₉₀ and C₉₆ fullerenes are well-known. In this present invention, C₆₀ fullerene is preferably used because of its small molecular size and superior resolving ability.

The malonic ester residue in the fullerene derivative (A) is a group, in which two hydrogen atoms are eliminated at the a carbon (position 2), and which is expressed by the general formula (1), and bound to the fullerene. The number of the malonic ester residues is an integer of 2 or more. Including a plurality of the malonic ester residues may significantly increase the solubility of the fullerene in a resist solvent. The greater the number of the malonic ester residues is, the greater the solubility in the resist solvent tends to be. Therefore, the more malonic ester residues are preferred; however, the maximum number of the residues is about 12, and preferably about 2 to 6.

In the malonic ester residue expressed by the general formula (1), the organic group R¹ and R² independently represent an alkyl group. The alkyl group may be selected from groups that increase solubility in a resist solvent without any limitation; however, an alkyl group having 1 to 20 carbons is preferred. The alkyl group is preferably a normal or branched chain, or a cyclic alkyl group that has 1 to 10 carbons for superior solubility in a resist solvent and superior resist pattern configuration.

Specific examples of the alkyl group include methyl, ethyl, n-propyl, isopropyl, n-butyl, sec-butyl, tert-butyl, n-pentyl, sec-pentyl, tert-pentyl, cyclopentyl, n-hexyl, sec-hexyl, cyclopentyl, nonyl, and decanyl groups. Among these, the lower alkyl groups including ethyl and tert-butyl groups are preferred.

The fullerene derivative (A) is preferably the methanofullerene compound expressed by the general formula (2) because of its small molecular size, superior resolving ability and synthesis of the fullerene derivative (A).

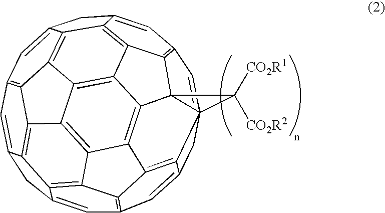

In the formula (2), n is an integer of 2 or more, and R¹ and R² independently represent an alkyl group, which may be identical or different from each other. n is an integer of up to about 12 as described reference with the malonic ester residue, preferably 2 to 6. These R¹ and R² are the same as the abovementioned R¹ and R².

In particular, when the alkyl group is a tertiary alkyl group such as a tert-butyl group, it disassociates by an acid generated from an acid generator to act as an acid-dissociative dissolution-controlling group, so that a photoresist composition in which the two major components are the fullerene derivative (A) and the acid generator, can be obtained. This composition is preferred since it has superior etching resistance, and forms a finer pattern. In addition, this composition is preferred since it exhibits a superior effect that remarkably reduced edge roughness.

A photoresist using a conventional fullerene or derivative thereof having inferior solubility in a resist solvent can only be incorporated as an additive added in a film forming component and acid generator. However, the solubility of the fullerene of the present invention in a resist solvent is high, so that the photoresist having the abovementioned two components (the fullerene derivative (A) and acid generator) as its major components can be obtained.

Nevertheless, the photoresist composition of the present invention is not limited to a photoresist component, in which these two components are included as the major components. A conventional film forming component and acid generator component may be incorporated into the photoresist composition. Since the solubility of the photoresist composition in the resist solvent increases, the amount of conventional components can increase in the photoresist composition. As a result, the obtained photoresist composition has superior etching resistance and reduced edge roughness. In addition, even if the amount of the fullerene derivative (A) increases, a superior resist pattern can be formed in the resist pattern configuration.

In the fullerene derivative (A) used for the photoresist composition of the present invention, it is not required that R¹ and R² in the general formula (2) be a tertiary alkyl group, which acts as an acid-dissociative dissolution-controlling group. R¹ and R² may be a tertiary alkyl group such as a tert-butyl group or lower alkyl group. In addition, the photoresist may be a positive-type or negative-type photoresist composition.

The fullerene derivative (A) can be obtained by an addition reaction of fullerene and malonic ester. In this case, an activated derivative, in which the a carbon of the malonic ester is halogenated with a deprotonating agent such as 1,8-diazabicyclo[5.4.0]undecene and halogen, can be used for the malonic ester.

The photoresist composition of the present invention, which is formed by dissolving the fullerene derivative (A) and the radiation sensitive acid generator (B) in an organic solvent, will be explained in the following.

The composition amount of the fullerene derivative (A) in the photoresist composition of the present invention is usually 0.1 to 150 parts by mass, preferably 1 to 15 parts by mass, for 100 parts by mass of resist solvent. In cases in which the composition amount of the fullerene derivative (A) is less than 0.1 parts by mass, the coating property and sensibility are degraded, and the pattern configuration is deteriorated as a resist; therefore, the composition amount is unpreferable. In the case in which the composition amount of the fullerene derivative (A) is more than 150 parts by mass, the solubility of the fullerene derivative in a resist solvent is deteriorated, so that the effects of the present invention will be impaired.

The acid generator (B) may be selected from a group of well known acid generators in a conventional chemically amplified resist, and used. For example, various conventional acid generators, such as onium salts including iodonium salts and sulfonium salts, oxime sulfonates, bis-alkyl or bis-aryl sulfonyldiazomethanes, diazomethane nitrobenzyl sulfonates, iminosulfonates and disulfones can be used without any limitations.

Specific examples of the diazomethane include bis(isopropylsulfonyl)diazomethane, bis(p-toluenesulfonyl)diazomethane, bis(1,1-dimethylethylsulfonyl)diazomethane, bis(cyclohexyl sulfonyl)diazomethane, bis(2,4-dimethylphenylsulfonyl)diazomethane, and the like.

The specific examples of the oxime sulfonate-type acid generator include a-(methylsulfonyloximino)-phenylacetonitrile, α-(methylsulfonyloximino)-p-methoxyphenylacetonitrile, α-(trifluoro-methylsulfonyloximino)-phenylacetonitrile, α-(trifluoro-methylsulfonyloximino)-p-methoxyphenylacetonitrile, α-(ethylsulfonyloximino)-p-methoxyphenylacetonitrile, α-(propylsulfonyloximino)-p-methylphenylacetonitrile, α-(methylsulfonyloximino)-p-bromophenylacetonitrile, and the like. Among these, α-(methylsulfonyloximino)-p-methoxyphenylacetonitrile is preferred.

Specific examples of the onium salt-type acid generator include trifluoromethane sulfonate or nonafluorobutane sulfonate of diphenyliodonium; trifluoromethane sulfonate or nonafluorobutane sulfonate of bis(4-tert-butylphenyl)iodonium; trifluoromethane sulfonate, heptafluoropropane sulfonate, or nonafluorobutane sulfonate of triphenylsulfonium; trifluoromethane sulfonate, heptafluoropropane sulfonate, or nonafluorobutane sulfonate of tri(4-methylphenyl)sulfonium; trifluoromethane sulfonate, heptafluoropropane sulfonate, or nonafluorobutane sulfonate of dimethyl(4-hydroxynaphtyl)sulfonium; trifluoromethane sulfonate of monophenyldimethylsulfonium; heptafluoropropane sulfonate or nonafluorobutane sulfonate of trifluoromethane sulfonate; trifluoromethane sulfonate, heptafluoropropane sulfonate, or nonafluorobutane sulfonate of diphenyl monomethyl sulfonium, and the like. Among the onium salt types, sulfonium salt types are preferred.

These may be used alone or in combinations of two or more acid generators. The composition amount of the acid generator, for example, is 0.01 to 5 parts by mass, preferably 0.1 to 3 parts by mass, for 100 parts by mass of the resist solvent. An amount below the lower limit may lead to insufficient latent image formation. On the other hand, an amount above the upper limit may lead to poor preservation stability as a resist composition.

The photoresist composition formed by dissolving the fullerene derivative (A) and the acid generator (B), and the film forming resin component in an organic solvent will be explained in the following.

The fullerene derivative (A) and the abovementioned acid generator (B) are as described above. The film forming resin component (C) is a base resin component that forms a resist coating when a photoresist is coated onto a substrate. In the positive-type photoresist composition, the component (C) is the resin (C1) (hereinafter referred to as “component (C1)”) having an acid-dissociative dissolution-controlling group, which increases solubility in alkali by acid action. In the negative-type photoresist composition, the component (C) is the alkaline soluble resin (C2) (hereinafter referred to as “component (C2)”), and used in combination with the crosslinking agent component (D) (hereinafter referred to as “component (D)”).

These film forming components can be employed selected from positive and negative type resists without any limitation.

Examples of the component (C2) include a novolac resin obtained by condensing phenols, for example, phenol; creosols such as phenol, m-creosol, p-creosol, and o-cresol; xylenols such as 2,3-xylenol, 2,5-xylenol, 3,5-xylenol, and 3,4-xylenol; formaldehydes of phenols, such as trialkylphenols, for example, 2,3,5-trimethylphenol, and 2,3,5-triethylphenol; with aldehydes, such as formaldehyde, paraformaldehyde and trioxane in the presence of an acid catalyst, according to a conventional method, and a polyhydroxy styrenic resin such as a hydroxystyrene homopolymer; a copolymer of a hydroxystyrene and another styrene monomer; a copolymer of hydroxystyrene and acrylic acid, methacrylic acid, or derivatives thereof; and the like.

The mass average molecular weight of the novolac resin is 2,000 to 30,000, and preferably 5,000 to 25,000. When the mass average molecular weight is less than the lower limit, the residual film ratio and the resist pattern deteriorate. Alternatively, when the mass average molecular weight is more than the upper limit, the resolving ability unpreferably deteriorates.

Examples of the hydroxystyrene monomer of the polyhydroxy styrenic resins include styrene, α-methylstyrene, p-methylstyrene, o-methylstyrene, p-methoxystyrene, p-chlorostyrene, and the like. The examples of the acrylic and methacrylic acid derivatives include methyl acrylate, ethyl acrylate, 2-hydroxyethyl acrylate, 2-hydroxypropyl acrylate, acrylic acid amide, acrylonitrile, and the methacrylic acid derivatives corresponding thereto. Among these, a copolymer of hydroxystyrene and styrene is preferred. The mass average molecular weight of the polyhydroxy styrenic resin is 1,000 to 10,000, and preferably 2,000 to 4,000.

The component (D) is a crosslinking agent that has at least one crosslinking group selected from the group consisting of a hydroxyalkyl group and a lower alkyl group, which is used as a conventional crosslinking agent of a chemically amplified negative-type resist without any limitation.

These crosslinking agents include an amino resin having a hydroxyl group or alkoxyl group; for example, the amino resins include melamine, urea, guanamine, glycoluril formaldehyde, succinyl amide-formaldehyde, and ethylene urea-formaldehyde resins. These resins are easily obtained by methylolating melamine, urea, guanamine, glycoluril, succinyl amide, or ethylene urea, and then alkoxylating a lower alcohol. NIKALAC Mx-750, NIKALAC Mw-30, and NIKALAC Mx-290 (by Sanwa Chemical co., LTD.) can be obtained for a practical usage.

For the component (C1), a resin, in which a hydroxy group or carboxyl group of a novolac resin, hydroxystyrene resin, or a copolymer resin containing a constitutional unit induced from methacrylic ester, is substituted with an acid-dissociative dissolution-controlling group, is preferably used.

The term “(meth)acrylic acid” herein refers to both or either of methacrylic acid, acrylic acid, or both. The term “(meth)acrylic ester induced constitutional unit” refers to a constitutional unit that is formed by cleaving ethylenic double bond of (meth)acrylic ester, and is hereinafter sometimes referred to as “(meth)acrylate constitutional unit”.

An example of the preferred resin component for the component (C1) includes a resin component of a positive-type resist including a unit that was selected from each of the following constitutional units (c-1) to (c-6).

The resin component increases alkaline solubility by acid action. In other words, the resin component is formed by at least two constitutional units consisting of at least one of the constitutional units (c-1), (c-2), (c-3), and (c-6). In the constitutional units (c-2), (c-3), and (c-6), an acid-dissociative dissolution-group is cleaved by action of an acid that is generated from an acid generator by exposure. The alkaline solubility thereby increases in a resin that in the beginning was insoluble in an alkaline developer. As a result, by exposure/development, a chemically amplified positive-type pattern can be formed.

Constitutional Unit (c-1)

The constitutional unit (c-1) is expressed by the general formula (3) below.

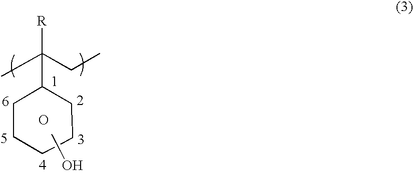

In the formula (3), R represents —H or —CH₃.

In the general formula (3), R is —H or —CH₃. The bonding position of —OH to the benzene ring is not limited in particular; however, the position 4 (para position) is preferred.

The amount of the constitutional unit (c-1) is 40 to 80 mol %, preferably 50 to 75 mol % in the resin. When the amount is more than 40 mol %, the solubility of the resin in an alkaline developer can increase, and an improved pattern configuration is effectively obtained. Alternatively, when the amount is less than 80 mol %, the constitutional unit (c-1) can stay in balance with other constitutional units.

Constitutional Unit (c-2)

The constitutional unit (c-2) is expressed by the general formula (4) below.

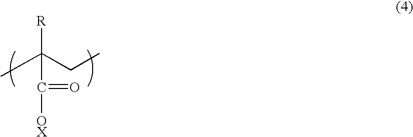

In the formula (4), R represents —H or —CH3; and X is an acid-dissociative dissolution-controlling group.

In the general formula (4), R is —H or —CH₃. The acid-dissociative dissolution-controlling group X is an alkyl group having a tertiary carbon atom, for example, an acid-dissociative dissolution-controlling group, in which the tertiary carbon atom of the tertiary alkyl group is bound to the ester group (—C(O)O—), or a cyclic acetal group, such as a tetrahydropyranyl group and a tetrahydrofuranyl group. The acid-dissociative dissolution-controlling group X may be arbitrarily used from any group other than the above-mentioned groups in a chemically amplified positive-type resist composition.

The constitutional unit (c-2) is preferably the unit expressed by the general formula (5) below.

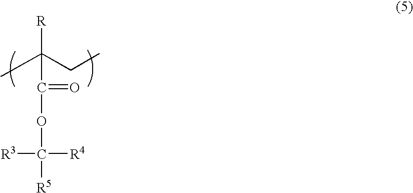

In the general formula (5), R represents —H or —CH₃; and R³, R⁴, and R⁵ may each independently be a lower alkyl group, which may have either a normal or branched chain, in which 1 to 5 carbons are preferably included. Alternatively, from R³, R⁴, and R⁵, two groups may be bound to form a monocyclic or polycyclic alicyclic group having 5 to 12 carbons. When no alicyclic group is included, R³, R⁴, and R⁵ are preferably a methyl group.

When a monocyclic alicyclic group is included, a cyclopentyl or cyclohexyl group is preferably included. Furthermore, among polycyclic alicyclic groups, the general formulas (6) and (7) are preferred.

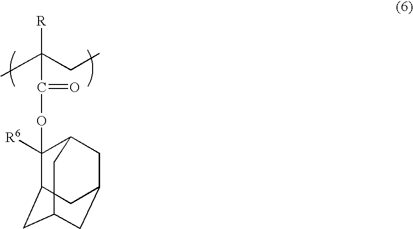

In the formula (6), R represents —H or —CH₃, and R⁶ may be a lower alkyl group, which may have either a normal or branched chain, and 1 to 5 carbons preferably included.

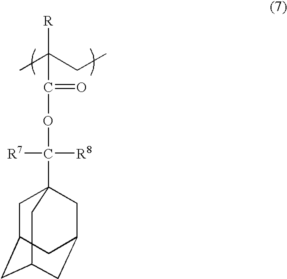

In the formula (7), R represents —H or —CH₃, and R⁷ and R⁸ may be a lower alkyl group, which may have either a normal or branched chain, and 1 to 5 carbons preferably included.

The amount of the constitutional unit (c-2) is 5 to 50 mol %, and preferably 10 to 40 mol % in the resin.

Constitutional Unit (c-3)

The constitutional unit (c-3) is expressed by the general formula (8) below.

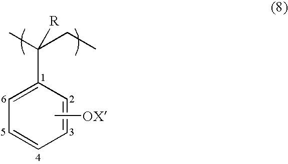

In the formula (8), R represents —H or —CH₃; and X′ represents an acid-dissociative dissolution-controlling group.

The acid-dissociative dissolution-controlling group X′ may be used from any groups other than the groups in a chemically amplified positive-type resist composition that is conventionally used. For example, a tertiary alkyloxycarbonyl group, such as a tert-butyloxycarbonyl group, a tert-amyloxycarbonyl group; a tertiary alkyloxycarbonylalkyl group, such as a tert-butyloxycarbonylmethyl group and a tert-butyloxycarbonylethyl group; a tertiaryalkyl group, such as a tert-butyl group and a tert-amyl group; a cyclic acetal group, such as a tetrahydropyranyl group and a tetrahydrofuranyl group; and an alkoxyalkyl group, such as an ethoxyethyl group and methoxypropyl group are included. Among these, a tert-butyloxycarbonyl group, a tert-butyloxycarbonylmethyl group, a tert-butyl group, a tetrahydropyranyl group, and an ethoxyethyl group are preferred.

In the general formula (8), a bonding position of—OX′ to the benzene ring is not limited in particular; however, the position 4 (para position) indicated in the formula is preferred. The amount of the constitutional unit (c-3) is 10 to 50 mol %, and preferably 20 to 40 mol % in the resin.

Constitutional Unit (c-4)

The constitutional unit (c-4) is expressed by the general formula (9) below.

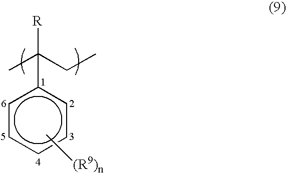

In the formula (9), R represents —H or —CH₃; R⁹ represents a lower alkyl group; and n is an integer of from 0 to 3.

In the formula (9), the lower alkyl group may be either of a normal chain or branched-chain, and preferably has 1 to 5 carbons; and n represents an integer of from 0 to 3, preferably 0.

The amount of the constitutional unit (c-4) is 1 to 40 mol %, preferably 5 to 25 mol % in the resin. When the amount is more than 1 mol %, the pattern configuration (film loss) is effectively improved, and when the amount is less than 40 mol %, the constitutional unit (c-4) can stay in balance with the other constitutional units.

Constitutional Unit (c-5)

The constitutional unit (c-5) is expressed by the general formula (10) below.

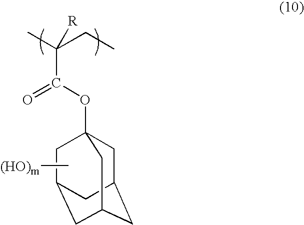

In the formula (10), R represents —H or —CH₃; and m is an integer from 1 to 3.

The amount of the constitutional unit (c-5) is 1 to 40 mol %, preferably 5 to 25 mol % in the resin. The solubility of the constitutional unit (c-5) is lower than that of the constitutional unit (c-1). Therefore, the component (C1) used in the present invention, in which the acid-dissociative dissolution-controlling group has been eliminated, has lower solubility in an alkaline developer than that of a resin in which the hydroxy groups of the polyhydroxystyrene are partially protected by an acid-dissociative dissolution-controlling group). As a result, sufficient insolubility in an alkaline developer can be obtained even though the lower protecting ratio of the component (C1) is lower than that of polyhydroxy styrenic resin; and thereby the developmental defect caused by the acid-dissociative dissolution-controlling group is regulated, and superior resolving ability can be achieved.

Constitutional Unit (C-6)

The constitutional unit (c-6) is expressed by the general formula (11).

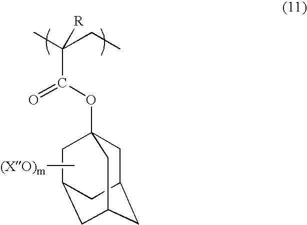

In the general formula (11), R represents —H or —CH₃; X” is an acid-dissociative dissolution-controlling group; and m is an integer from 1 to 3.

The amount of the constitutional unit (c-6) is 1 to 30 mol %, preferably 2 to 25 mol % in the resin. This unit is a unit, in which the hydroxy group in the constitutional unit (c-5) is protected by an acid-dissociative dissolution-controlling group similar to that of X′. The acid-dissociative dissolution-controlling group X″ includes the same examples as those of X′, preferably a 1-alkoxyalkyl group, such as a 1-ethoxy ethyl group and a 1-methoxy propyl group. This unit and the constitutional unit (C-3) in the component (C1) are used in 10 to 35 mol %, preferably 20 to 30 mol %, resulting in superior resolving ability.

The component C1 is formed by at least two constitutional units, which are the constitutional unit (c-1) and at least one constitutional unit selected from the constitutional units (c-2), (c-3), and (c-6).

Examples of these copolymers include the copolymer (a) having the constitutional units (c-1) and (c-2); the copolymer (b) having the constitutional units (c-1), (c-2), and (c-4); the copolymer (c) having the constitutional units (c-1) and (c-3); the copolymer (d) having the constitutional units (c-1), (c-3), and (c-4); the copolymer (f) having the constitutional units (c-1), (c-3), (c-5), and (c-6), and the like. In addition, these copolymers may be mixed with each other. Among these, at least one copolymer preferably selected from the copolymer (c), the copolymer (d), and the copolymer (e) has superior resolving ability.

The mass average molecular weight of the resin in the component (C1) is more than 2000, preferably 3,000 to 30,000, and more preferably 5,000 to 20,000 based on a polystyrene standard by way of GPC. In addition, the mass average molecular weight of the copolymer (e) is preferably 2,000 to 8,500, and more preferably 4,500 to 8,500 based on the polystyrene standard. The mass average molecular weight which is expressed hereafter based on the polystyrene standard. When the mass average molecular weight of the copolymer (e) is more than 8,500, a micro bridge easily occurs, and when it is less than 2,000, the etching resistance deteriorates.

The component (C1) can be obtained by polymerizing monomers, which are materials for the constitutional units by using a conventional method.

In the photoresist composition formed by dissolving the fullerene derivative (A) (hereinafter referred to as “component (A)”), the acid generator (B) (hereinafter referred to as “component (B)”), and the film-forming resin component (C) (hereinafter referred to as “component (C)”) in an organic solvent, the component (A) was used at a ratio of 0.1 to 50 parts by mass, preferably 1 to 20 parts by mass, and the component (B) was used at a ratio of 0.1 to 20 parts by mass, preferably 1 to 10 parts by mass based on 100 parts by mass of the component (C).

In the positive-type photoresist composition, the component (A) was used at a ratio of 0.1 to 50 parts by mass, preferably 1 to 20 parts by mass; and the component (B) was used at an ratio of 0.1 to 20 parts by mass, preferably 1 to 10 parts by mass based on 100 parts by mass of the component (C1).

In the negative-type photoresist composition, the component (A) was used at a ratio of 0.1 to 50 parts by mass, preferably 1 to 20 parts by mass; and the component (B) was used at a ratio of 0.1 to 20 parts by mass, preferably 1 to 10 parts by mass based on 100 parts by mass of the component (C2). When the ratio deviates from the abovementioned range, the effect in reducing edge roughness tends to decrease as a resist. Furthermore, the coating properties and sensitivity as a resist are degraded, and the pattern configuration is deteriorated.

In the photoresist of the present invention, for example, a compound which is a solubility controlling agent, and has at least one aromatic ring or aliphatic ring at a molecular weight of 100 to 500, in which at least one kind of a substituent capable of controlling alkaline-solubility is introduced into a phenol, alcohol, or carboxylic hydroxy group, and combined in a photoresist of the present invention. Examples of the acid-dissociative substituents include tertiary alkyl, tertiary alkoxycarbonyl, tertiary alkoxycarbonylalkyl, and chain or cyclic alkoxyalkyl groups.

Specific examples thereof include a tertiary alkyl group, such as a tert-butyl group; a tertiary alkoxycarbonyl group, such as a tert-butoxycarbonyl group; a tertiary alkoxycarbonylalkyl group such as a tert-butoxycarbonylmethyl group; a chain alkyloxyalkyl group such as a methoxymethyl, a 1-ethoxyethyl, and a 1-propoxyethyl group; and a cyclic alkoxyalkyl group, such as a tetrahydropyranyl and a tetrahydrofuranyl group.

The amount of the dissolution-controlling agent in the photoresist composition according to the present invention is 2 to 30 parts by mass, and preferably 3 to 10 parts by mass for 100 parts by mass of the component (C).

The photoresist composition according to the present invention may be prepared via dissolving a respective component in an organic solvent. The organic solvent used for the present invention may be any solvent that can dissolve the respective components to form a uniform solution; and conventionally, may be any one or more solvents that are selected from a group of known solvents utilized as a solvent for a chemically amplified resist. Specific examples thereof include ketones such as y-butyrolactone, acetone, methylethylketone, cyclohexanone, methylisoamylketone and 2-heptanone; polyalcohols and derivative thereof such as ethylene glycol, ethylene glycol monoacetate, diethylene glycol, diethylene glycol monoacetate, propylene glycol, propylene glycol monoacetate and dipropylene glycol, and monomethylether, monoethylether, monopropylether, monobutylether or monophenylether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate and ethyl ethoxypropionate. These organic solvents may be used alone or in combination. Among these, the fullerene derivative (A) exhibits superior solubility in propylene glycol monomethyl ether acetate (PGMEA), ethyl lactate (EL), and methylamylketone. When the organic solvents are mixed, the compound ratio of propylene glycol monomethyl ether acetate (PGMEA) and polar solvent may be freely determined based on the compatibility of the PGMEA and polar solvent, but preferably, it is from 1:9 to 9:1, and more preferably from 2:8 to 8:2. More specifically, when ethyl lactate (EL) is mixed as a polar solvent, the mass ratio of PGMEA:EL is preferably from 2:8 to 8:2, more preferably from 3:7 to 7:3.

There is no set limit on the amount of solvent used; the amount is adjusted depending on the thickness of the film, so as to make it possible to coat the resist composition onto substrates and the like. In general, the solid content of the resist composition is 2 to 20 mass %, preferably 5 to 15 mass %.

In order to enhance the pattern configuration and the post exposure stability of the latent images formed by the pattern wise exposure of the resist layers, a nitrogen-containing organic compound (E) (hereinafter referred to as component (E)) may be optionally incorporated into the photoresist composition according to the present invention. The component (E) may be selected from various compounds proposed in the art, preferably amines, and in particular secondary aliphatic amines and tertiary aliphatic amines.

The aliphatic amines refer to amines of alkyl or alkyl alcohol having 15 or less carbons; examples of the secondary and tertiary amines include trimethylamine, diethylamine, triethylamine, di-n-propylamine, tri-n-propylamine, tripentylamine, trihexylamine, triheptylamine, trioctylamine, tridecanylamine, tridodecylamine, tritetradecanylamine, diethanolamine, triethanolamine, and triisopropanolamine. Among these, in particular, a tertiary alkanolamine such as triethanolamine and triisopropanolamine are preferable. These may be used alone or in combination.

The component (E) is usually employed at an amount of 0.1 to 40 parts by mass, more preferably 0.01 to 20 parts by mass based on 100 parts by mass of the component (A). When the component (E) is used at less than 0.01 parts by mass, the advantageous effect is not provided, and when it is more than 40 parts by mass, the sensitivity and pattern configuration deteriorate.

In order to prevent degradation in sensitivity due to the component (E), and to improve the resist pattern configuration, and enhance the post exposure stability of the latent image formed by the pattern wise exposure of the resist layer, an organic carboxylic acid or phosphorous oxo acid or derivative thereof (F) (hereinafter referred to as component (F)) may be additionally incorporated as an optional component. Furthermore, the components (E) and (F) may be utilized alone or in combination.

Preferable examples of the organic carboxylic acids include malonic acid, citric acid, malic acid, succinic acid, benzoic acid, and salicylic acid.

The phosphorous oxo acid or derivative thereof may be phosphoric acid and its ester derivatives, such as phosphoric acid, di-n-butyl phosphate and diphenyl phosphate; phosphonic acid and its ester derivatives, such as phosphonic acid, dimethyl phosphonate, di-n-butyl phosphonate, phenyl phosphonic acid, diphenyl phosphonate and dibenzyl phosphonate; and phosphinic acid and its ester derivatives, such as phosphinic acid and phenylphosphinic acid. Among these salicylic acid and phenyl phosphonic acid are preferred.

The component (F) is used at a ratio of 0.01 to 40 parts by mass, more preferably 0.01 to 20 parts by mass of the component (A). When the component (E) is used at a ratio of less than 0.01 parts by mass, the advantageous effect is not provided, and when it is more than 40 parts by mass, the sensitivity and the pattern configuration deteriorate.

The photoresist composition according to the present invention may further contain miscible additives such as additional resins to improve the properties of the resist film, surfactants to upgrade the coating properties, and plasticizers, stabilizers, colorants, and halation-inhibiting agents and the like if desired.

The method for forming the resist pattern of the present invention which includes steps of: coating the photoresist composition onto a substrate to form a resist film, exposing the resist pattern, and developing the photoresist film after the exposure to form a resist pattern.

For example, the method for forming a resist pattern is described below. First, the photoresist composition is applied by a spinner and the like onto a substrate such as a silicon wafer, and pre-baked at 80 to 150 degrees C. for 40 to 120 seconds, preferably 60 to 90 seconds. Electron radiation, far-ultraviolet rays and the like are selectively exposed onto the obtained film through the desired mask pattern by using an electron radiation lithography system. The mask pattern may be used for exposure as mentioned above, or it may be directly exposed to electron radiation and etched without the mask pattern. After exposure or etching, PEB (post-exposure baking) is conducted at 80 to 150 degrees C. for 40 to 120 seconds, preferably 60 to 90 seconds. Second, the photoresist film after PEB is developed by using an alkali photographic developer, for example, 0.1 to 10 mass % of tetramethylammonium hydroxide water solution. In this way, the resist pattern, which exactly matches the mask pattern, can be obtained.

An organic or inorganic antireflection layer may be placed between a substrate and a coating layer of a resist composition. The wavelength of the irradiation beam is not particularly limited; the irradiation source may be an ArF excimer laser, a KrF excimer laser, an F₂ excimer laser, EUV (extreme ultraviolet), VUV (vacuum ultraviolet), EB (electron beam), an X-ray, a soft X-ray, and the like.

### EXAMPLES

Examples Below, the present invention will be explained in detail by way of examples, which are merely for properly illustrating the invention, and do not limit the present invention in any way.

### Example 1

Examples Below, the present invention will be explained in more detail by way of examples, which are merely for properly illustrating the invention, and do not limit the present invention in any way.

Synthesis of Fullerene Derivative (A): Methanofullerene Derivatives (12) to (18)

### Synthesis Example 1: Diethylmalonic Acid Poly-Adduct

16.8 g of diethylmalonic acid (by Tokyo Chemical Industry Co., Ltd.) was added into a 2 L glass flask in Nitrogen gas stream, 150 cm³ of 1,2,4-trimethylbenzene and 15.1 g of DBU(1,8-diazabicyclo[5.4.0]undec-7-ene)(by Tokyo Chemical Industry Co., Ltd.) were added, and the mixture was stirred and maintained at 4 degrees C. Next, 24.5 g of iodine dissolved in 1,2,4-trimethylbenzene, having a dark purple color, was slowly dripped into the obtained reaction liquid after attemperation. While dripping, the temperature in the flask was maintained at 11 degrees C. by using an ice bath. After dripping, the temperature was brought to ambient temperature. The reaction liquid in the flask was in a brown colored suspension.

Then, 5.00 g of fullerene C₆₀ (by Frontier Carbon Corporation, with a molecular weight of 720) dissolved in 350 cm³ of 1,2,4-trimethylbenzene, was added to the reaction liquid in the flask while stirring. Next, 16.2 g of DBU(1,8-diazabicyclo[5.4.0]undec-7-ene)(by Tokyo Chemical Industry Co., Ltd.) diluted with 5 cm³ of 1,2,4-trimethylbenzene was slowly dripped into the reaction while being stirred. Thin-layer liquid chromatography confirmed that the adduct composition ration in the reaction liquid was at its optimum stability at adduct peak 5, and the reaction was finished.

The reaction liquid was washed following manner. The reaction layer, which is an organic phase, was washed four times with a saturated sodium sulfite water solution. In the same way, the obtained organic phase was washed twice with 100 cm³ of 1N-sulfuric acid water solution, and then three times with 200 cm³ of pure water. The solvent of the organic phase was removed under vacuum to obtain a chestnut brown solid body.

The obtained chestnut brown solid body was measured by liquid chromatography-mass spectrometry (LC-MS), the peaks (M/Z=1194, 1352, 1510, 1668), respectively correspond to the 2-, 4-, 5-, and 6-adducts of fullerene C₆₀-diethylmalonic acid (hereinafter respectively referred to as “methanofullerenes (16), (14), (13), and (12)”) respectively expressed by the following chemical formulas (16), (14), (13) and (12) were confirmed.

In addition, the solid body was measured by an infrared absorption spectrum, and the absorption of carbon hydride bond at 3000 to 2900 cm⁻¹, the carbonyl absorption from an ester group at 1,750 cm⁻¹, and the absorption of carbon-oxygen bond at 1,240 cm⁻¹ were detected, so that the existence of an ethyl ester group was confirmed. Furthermore, the solid body was measured by a ¹H-NMR measurement in deuterated chloroform, and then multiple lines were observed at 4.55 to 4.20 ppm and 1.48 to 1.20 ppm, of which the integral ratio was 2:3, so that the existence of an ethyl ester group was confirmed. By using LC analysis to confirm the reaction end point, it was proved that the 5-adduct (the methanofullerene (13)) expressed by the chemical formula (13), was the main component. The solid body was then separated with a mixed solvent of n-hexane and ethyl acetate by a silica gel chromatograph to obtain the 2-, 4-, 5-, and 6-adducts of fullerene C₆₀-diethylmalonic acid, which respectively correspond to the methanofullerenes (16), (14), (13), and (12).

### Synthesis Example 2: Malonic acid-di-tert-butyl Poly-Adduct)

9.80 g of malonic acid-di-tert-butyl (by Aldrich Chemical Company, Inc.) was added into a 2 L glass flask in a nitrogen gas stream, 150 cm³ of 1,2,4-trimethylbenzene and 6.50 g of DBU(1,8-diazabicyclo(5.4.0]undec-7-ene)(by Tokyo Chemical Industry Co., Ltd.) were then added, and the mixture was stirred and maintained at 4 degrees C. 10.9 g of iodine dissolved in 130 cm³ of 1,2,4-trimethylbenzene, having a dark purple color, was slowly dripped into the obtained reaction liquid after attemperation. While dripping, the temperature in the flask was maintained at 11 degrees C. by using an ice bath. After dripping, the temperature was brought to ambient temperature. The reaction liquid in the flask was in a brown colored suspension.

Then, 5.00 g of fullerene C₆₀ (by Frontier Carbon Corporation with a molecular weight of 720) was dissolved in 350 cm³ of 1,2,4-trimethylbenzene, and added into the reaction liquid in the flask while stirring. Next, 6.90 g of DBU(1,8-diazabicyclo[5.4.0]undec-7-ene) (by Tokyo Chemical Industry Co., Ltd.) diluted with 5 cm³ of 1,2,4-trimethylbenzene was slowly dripped into the reaction liquid while being stirred. Thin-layer liquid chromatography confirmed that the adduct composition ration in the reaction liquid was at its optimum stability at adduct peak 4, and the reaction was finished. The obtained reaction liquid was washed by solvent extract in the same way as Synthesis 1 to obtain 9.50 of a chestnut brown solid body.

The obtained chestnut brown solid body was measured by liquid chromatography-mass spectrometry (LC-MS), the peaks (M/Z=1362, 1576), respectively correspond to the 3-, and 4-adducts of fullerene C₆₀-malonic acid-di-tert-butyl (hereinafter respectively referred to as “methanofullerenes (20) and (19)”) respectively expressed by the following chemical formulas (20) and (19) were confirmed.

In addition, the solid body was measured by an infrared absorption spectrum, and the absorption of carbon hydride bond at 3000 to 2900 cm⁻¹, the carbonyl absorption from an ester group at 1,750 cm⁻¹, and the absorption of carbon-oxygen bond at 1,240 cm⁻¹ were detected, so that the existence of a tert-butyl ester group was confirmed. Furthermore, the solid body was measured by a ¹H-NMR measurement in deuterated chloroform, and then multiple lines were observed at 1.74 to 1.50 ppm, so that the existence of a tert-butyl ester group was confirmed.

By using LC analysis to confirm the reaction end point, it was proved that the 4-adduct (the methanofullerene (19)) was the main component. The solid body was then separated with a mixed solvent of n-hexane and ethyl acetate by a silica gel chromatograph to obtain fullerene the C₆₀-malonic acid-tert-butyl ester adduct, which was the methanofullerene (19).

### Examples 1 to 5 and Comparative Examples 1 and 2

The solubility of Methanofullerene Derivatives in a Resist Solvent

Solubility of the methanofullerene derivative of the present invention in the resist solvents, propylene glycolmonomethyl ether acetate, (hereinafter referred to as “PGMEA”), methyl amyl ketone, which is 2-heptanone (MAK), and ethyl lactate (EL) was studied. In other words, 100 mg of each of the methanofullerenes (12) to (14), (16), and (19) was added into 100 mg of each of PGMEA, MAK, and EL, and then stirred at ambient temperature to prepare 50 mass % of methanofullerene solution in the final concentration (Examples 1 to 5). In addition, the solubility of methanofullerene as expressed by the chemical formula (17), in which the substituent number n is 1, (herein after referred to as “methanofullerene (17)”) was studied in Comparative Example 1 in the same way. In addition, the solubility of methanofullerene expressed by the chemical formula (18), in which the substituent number n is 0, (herein after referred to as “methanofullerene (18)”) was studied in Comparative Example 2 in the same way. The solubility was confirmed by visual observation.

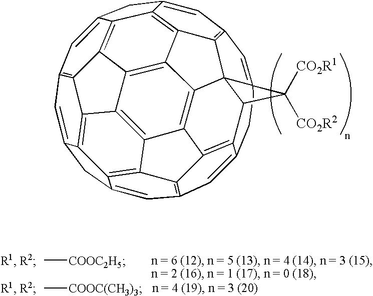

Chemical Formulas of Methanofullerenes (12) to (20)

TABLE 1
Result of Solubility into Resist Solvent

| | | PGMEA | MAK | EL |
|---|---|---|---|---|
| Example 1 | Methanofullerene | Promptly | Promptly | Promptly |
| | (12) | Dissolved | Dissolved | Dissolved |
| Example 2 | Methanofullerene | Promptly | Promptly | Promptly |
| | (13) | Dissolved | Dissolved | Dissolved |
| Example 3 | Methanofullerene | Promptly | Promptly | Promptly |
| | (14) | Dissolved | Dissolved | Dissolved |
| Example 4 | Methanofullerene | Dissolved | Dissolved | Dissolved |
| | (16) | | | |
| Example 5 | Methanofullerene | Promptly | Promptly | Promptly |
| | (19) | Dissolved | Dissolved | Dissolved |
| Comparative | Methanofullerene | Not | Not | Not |
| Example 1 | (17) | Dissolved | Dissolved | Dissolved |
| Comparative | C₆₀ Fullerene | Not | Not | Not |
| Example 2 | | Dissolved | Dissolved | Dissolved |

The result of the solubility was shown in table 1. As shown in Table 1, the methanofullerenes (12) to (14), (16), and (19), in which the substituent number n is from 6 to 2 respectively, were dissolved into the resist solvent, in particular, the methanofullerenes, in which the substituent number n is 4 or more were superior than others. Alternatively, the methanofullerenes (18) and (17), in which the substituent number n is 0 and 1 respectively, were undissolved in the resist solvent.

### Example 6 and Comparative Example 3

Evaluation of Etching Resistance

500 mg of the methanofullerene (12) was dissolved into 9.7 ml of PGMEA to prepare 5 mass % of methanofullerene (12)-PGMEA solution. After a methanofullerene film with a thickness of 120 nm was formed on a silicon substrate with this methanofullerene PGMEA solution, by way of a spin coat method, an etching treatment was applied for 30 seconds with a oxide film etching machine (TCE-7612X, by TOKYO OHKA KOGYO CO., LTD.) using etching gas (CF₄/CHF₃/He=30/30/100 sccm, at 300 mTorr of pressure and 600 W of high-frequency power). In Example 6, the etched film thickness was measured using by the methanofullerene (12) film, the etching resistance ratio to Comparative Example 3 were evaluated. In Comparative Example 3, the etched film thickness was measured using by polyhydroxystyrene (PHS).

TABLE 2
Evaluation Result of Etching Resistance

| | | Etched | Etching |
|---|---|---|---|
| | | Thickness | Resistance |
| | | (mm) | Ratio |
| Example 6 | Methanofullerene (12) | 37.7 | 1.5 times |
| | | | of stonger |
| Comparative | PHS | 56.7 | 1.0 |
| Example 3 | | | |

As shown in Table 2, the etching resistance of the methanofullerene (12) was stronger 1.5 times of that of PHS in Comparative Example 3.

### Evaluation of Two-Component System Photoresist Composition Example 7

100 parts by mass of the methanofullerene (19), (R¹ and R²=tert-butyl group, n=4), and 20 parts by mass of triphenyl sulfonium trifluoromethane sulfonate (hereinafter referred as “TPS-TF (acid generator)”) were dissolved into 1880 parts by mass of methyl amyl ketone (MAK) to prepare a two-component system positive-type photoresist composition in 6.0 mass % of homogeneous MAK solution (hereinafter referred as “resist composition 1”). The prepared resist composition 1 was applied onto a silicon substrate by a spin coat method, and baked at 130 degrees C. for 90 seconds to prepare resist film with thickness of 100 nm. 70 KeV of electron radiation was exposed to the prepared resist film for electron radiation by using an electron radiation lithography system (HL-800D VSB, by Hitachi Instruments Service Co., Ltd.). The resist film was baked at 130 degrees C. for 90 seconds, and then developed by a 2.38% of tetramethyl ammonium hydroxide water solution (hereinafter referred as “NMD-W”) for 60 seconds.

As a result, a resist pattern with a 50 nm 1:1 line-and-space (L/S) resist pattern size was formed by exposure (180 μC/cm²). Subsequently, when the resist pattern was observed with a scanning electron microscope (SEM), it had an excellent configuration.

### Example 8

parts by mass of tri-n-octyl amine and 0.05 parts by mass of salicylic acid were dissolved in the resist composition used in Example 7 to prepare a two-component system positive-type photoresist composition in 6.0 mass % homogeneous MAK solution (hereinafter referred as “resist composition 2”), and form a resist pattern in the same way as Example 7. As a result, a resist pattern with a 50 nm 1:1 line-and-space (L/S) resist pattern size was formed by optimum exposure (230 μC/cm²). Subsequently, when the resist pattern observed with a scanning electron microscope (SEM), it had an excellent configuration.

### Comparative Example 4

In the methanofullerene expressed by the general formula (2), a resist pattern was formed using by the methanofullerene, in which both of R¹ and R² are ethyl groups and n=1; however, the pattern configuration was not developed. Edge Roughness Reduction Effect of Chemically Amplified Negative-Type Photoresist Composition

### Example 9 and 10, and Comparative Example 5

100 parts by mass of alkaline soluble resin (VPS2520, mass average molecular weight=3600, dispersity=2), 5 or 10 parts by mass of the methanofullerene (12), 5 parts by mass of tri-phenyl sulfonium nonafluorobutane sulfonate (hereinafter referred as “TPS-Nf”), 0.8 parts by mass of tri-n-octyl amine, 0.3 parts by mass of salicylic acid, and 10 parts by mass of methoxymethylated propylene urea as a cross-linking agent were dissolved in 1100 parts by mass of PGMEA as a uniform solution to obtain a negative-type resist composition (hereinafter a composition containing 5 mass % of methanofullerene (12) is referred to as “resist composition 3”, and a composition containing 10 mass % of methanofullerene (12) is referred to as “resist composition 4”.). The prepared resist compositions 3 and 4 were applied onto silicon substrates respectively by a spin coat method, and baked at 110 degrees C. for 90 seconds to prepare chemically amplified resist films for electron radiation with a thickness of 250 nm. Then, the negative-type resist film prepared from the negative-type composition 3 was studied in Example 9, and the negative-type resist film prepared of the negative-type composition 4 was studied in Example 10. In Comparative Example 5, the chemically amplified negative-type resist film for electron radiation was prepared from the same negative-type composition without adding the methanofullerene (12).

After these chemically amplified negative-type resist films for electron radiation were respectively exposed to 70 KeV of electron radiation by using an electron radiation lithography system (HL-800D VSB, by Hitachi Instruments Service Co., Ltd.), the resist films were baked at 100 degrees C. for 90 seconds, and then developed by 0.26 N of tetramethyl ammonium hydroxide (TMAH) water solution for 60 seconds. As a result, in Examples 9 and 10, isolated resist pattern was formed with a 120 nm resist pattern size by optimum exposure. In addition, the edge roughness was observed by a scanning electron microscope (SEM) to determine the line wise roughness (LWR) in nm, and the results were shown in Table 3.

TABLE 3
Measurement Result of Edge Roughness

| | Additive Rate (wt %) of | |
|---|---|---|
| | Methanofullerene (12) | LWR (nm) |
| Comparative Example 5 | 0 | 7.9 |
| Example 9 | 5 | 6.3 |
| Example 10 | 10 | 6.1 |

As shown in Table 3, in the chemically amplified negative-type resist film for electron radiation with methanofullerene (12) added (Examples 9 and 10), an LWR reduction was observed and a reduction in edge roughness was confirmed, as compared to Comparative Example 5.

Pattern Configuration of Three-Component System Positive-Type Photoresist Composition

### Example 11

A copolymer (mole ratio=80:20,-mass average molecular weight(Mw)=8,000) in which the constitutional unit (c-1), expressed by the general formula (3) (in the general formula (3), p-hydroxystyrene unit in which a hydroxy group is bound to the para position), and the constitutional unit (c-5), expressed by the general formula (10) (in the general formula (10), an adamantanol methacrylate unit R is a methyl group, and a hydroxy group is bound to position 3) were copolymerized; and ethyl vinyl ether was reacted in the presence of an acid catalyst by a well-known method to obtain the resin (A2), in which the hydroxy group of the copolymer was protected by a 1-ethoxyethyl group. As a result of analysis of this resin (A2) by ¹H-NMR, the number of 1-ethoxyethyl groups was 20% based on the total number of hydroxy groups in p-hydroxystrene and adamantanol. Therefore, the protection ratio of the hydroxy groups was confirmed to be 20 mol %. For 100 parts by mass of this resin, 10 parts by mass of the methanofullerene (12), 8 parts by mass of the sulfonate expressed by the following chemical formula (21), 1.6 parts by mass of tri-n-octyl amine, and 0.64 parts by mass of salicylic acid were dissolved in 1890 parts by mass of PGMEA to obtain the positive-type photoresist composition (hereinafter referred as “resist composition 5”) as a uniform solution.

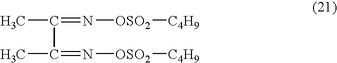

The chemically amplified positive-type resist composition for electron radiation 5 was baked onto a silicon substrate at 100 degrees C. for 90 seconds by a spin coat method to prepare a chemically amplified positive-type resist film for electron radiation with a thickness of 150 nm.

After these chemically amplified positive-type resist films for electron radiation were respectively exposed to 70 KeV of electron radiation by using an electron radiation lithography system (HL-800D VSB, by Hitachi Instruments Service Co., Ltd.), the resist films were baked at 110 degrees C. for 90 seconds, and then developed by 2.38 mass % of a TMAH water solution for 60 seconds.

As a result, a resist pattern with a 100 nm 1:1 line-and-space resist pattern size was formed by optimum exposure (42 μC/cm²). Subsequently, when the resist pattern was observed with a scanning electron microscope (SEM), it had an excellent configuration. In addition, the edge roughness was observed by a scanning electron microscope (SEM) to determine that the line wise roughness (LWR) was 7.4 nm.

### Example 12

The positive-photoresist composition (hereinafter referred as “resist composition 6”) was obtained in the same manner as Example 11, except that the same amount of the methanofullerene (19) was used in place of the methanofullerene (12). Then, a resist pattern was formed in the same manner as Example 11. As a result, a resist pattern with a 100 nm 1:1 line-and-space resist pattern size was formed by optimum exposure (52 μC/cm²). Subsequently, when the resist pattern was observed by a scanning electron microscope (SEM), it had an excellent configuration. In addition, it was determined in the same manner as in Example 11 that the LWR was 9.1 nm.

### Comparative Example 1

The positive-photoresist composition (hereinafter referred as “resist composition 7”) was obtained in the same manner as Example 11, except that the methanofullerene (12) was removed. Then, a resist pattern was formed in the same manner as Example 11. As a result, a resist pattern with a 100 nm 1:1 line-and-space resist pattern size was formed by optimum exposure (42 μC/cm²). Subsequently, when the resist pattern was observed by a scanning electron microscope (SEM), it had an excellent configuration. However, it was determined in the same manner as in Example 11 that the LWR was 11.1 nm, resulting in unsatisfactory.

### INDUSTRIAL APPLICABILITY

The photoresist composition containing the fullerene derivative of the present invention has superior etching resistance and reduced edge roughness, and can form a resist pattern with a superior pattern configuration.

1. A photoresist composition, comprising: a fullerene derivative (A) having two or more malonic ester residues.

2. The photoresist composition according to claim 1, wherein the malonic ester residue is the group expressed by the general formula (1) below, 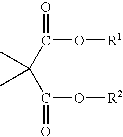
in which, R¹ and R² independently represent an alkyl group, which may be identical or different from each other.

3. The photoresist composition according to claim 1, in which the fullerene derivative (A) is a compound, expressed by the general formula (2) below, 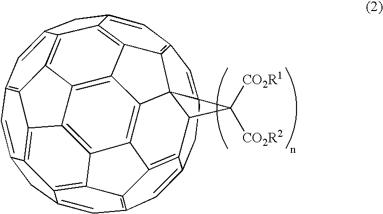
in which, n is an integer of 2 or more, and R¹ and R² independently represent an alkyl group, which may be identical or different from each other.

4. The photoresist composition according to claim 3, wherein the alkyl group has a normal or branched chain, or cyclic alkyl group having 1 to 10 carbons, and n is an integer from 2 to 10.

5. The photoresist composition according to claim 1, comprising the fullerene derivative (A), a radiation sensitive acid generator (B), and an organic solvent.

6. The photoresist composition according to claim 5, further comprising a film forming resin component (C).

7. The photoresist composition according to claim 6, wherein the photoresist composition is positive-type, and the film formation resin component (C) has an acid-dissociative dissolution-controlling group, which is a resin (C1) that increases solubility to alkali by acid action.

8. The photoresist composition according to claim 6, wherein the photoresist composition is negative-type, the component (C) is an alkaline soluble resin (C2) and a crosslinking agent component (D)

9. The photoresist composition according to claim 1, further comprising a nitrogen-containing organic compound.

10. The photoresist composition according to claim 1, further comprising an organic carboxylic acid.

11. A method for forming the resist pattern, comprising steps of:
coating the photoresist composition according to claim 1 onto a substrate to form a resist film,
exposing the resist pattern, and
developing the photoresist film after the exposure to form a resist pattern.
